(19) United States
(12) Patent Application Publication
(10) Pub. No.: US 2008/0280060 A1
(43) Pub. Date: Nov. 13, 2008

(54) METHOD FOR PROVIDING UNIFORM WEATHERING RESISTANCE OF A COATING

(76) Inventors: Jason P. Beaudoin, Livonia, MI (US); Keith D. Weiss, Fenton, MI (US); Jonathan R. Sargent, (US); Ken Foster, Brighton, MI (US); Sunitha K. Grandhee, Novi, MI (US)

Correspondence Address: EXATEC;C/O BRINKS HOFER GILSON & LIONE, 524 South Main Street, Suite 200, Ann Arbor, MI, 48104, US

(21) Appl. No.: 12/113,372

(22) Filed: May 1, 2008

Related U.S. Application Data
(60) Provisional application No. 60/915,325, filed on May 1, 2007.

(51) Int. Cl. C08F 2/46; B05D 1/36; H05H 1/24

(52) U.S. Cl. 427/487; 427/261; 427/569

(57) ABSTRACT

A process for flow, dip, or curtain coating a plastic panel with a weather resistant coating system of relatively uniform thickness is presented. More specifically, the process includes the step of rotating the plastic panel by about 180 degrees between the application of subsequent coating layers in order to minimize the variation in thickness measured near the top and bottom of the coated panel. The coatings are applied to the plastic panel at a predetermined coating angle (φ).

This application claims the benefit of U.S. Provisional Application Ser. No. 60/915,325 filed on May 1, 2007, entitled “LEVELING OF WEATHER RESISTANT COATING THICKNESS”, the entire contents of which are incorporated herein by reference.

### FIELD

This invention relates to coated parts, such as automotive glazing, wherein a coating is applied by a flow coating, dip coating, or curtain coating method.

### BACKGROUND

The application of a primer and a weatherable, silicone hard-coat to a plastic part, such as a polycarbonate window for automotive glazing, is typically done using a flow coating process. In a conventional flow coating process, the coating is pumped from a first reservoir through hoses and nozzles and applied to the part's surface located near the top of the part. From there it flows over and down the sides of the part using gravity as its means of conveyance. Any excess coating leaves the bottom of the window and drains into a shallow second reservoir. The excess coating in this second reservoir is then filtered, the solvent ratio determined and adjusted for loss caused by evaporation prior to being recycled back to the first reservoir for application to another part. This type of process is capable of coating large, non-planar parts, such as a molded polycarbonate window.

However, flow coating suffers from the inability to apply a homogenous coating thickness profile. This phenomenon is due to what is called a “wedge effect”. This “wedge effect” is caused by the flow of the coating down the part's surface due to gravity, the evaporation rate of the solvents in the coating, and the rheological flow properties exhibited by the coating. A similar effect is also observed for the application of a coating using either dip coating or curtain coating methods. Due to this effect, the coating thickness can exhibit a wide variation between the top and the bottom of the part. This variation increases as the length of the part's surface over which the coating flows becomes longer. The end result of such a variation in coating thickness is a variation in the properties exhibited by the coated part. For example, a flow coated, weatherable coating having dispersed UVA molecules will provide weathering protection to the underlying part based on the amount of UVA in the coating. In this case, a thicker coating layer will allow more UVA to be located on the surface of the part, thereby, providing a greater degree of protection. Thus the top of the part (thin coating layer) will exhibit a greater degree of wear due to weathering than the bottom of the part (thick coating layer).

Many other coating techniques known to apply a homogenous thickness of a coating, such as spray coating or spin coating can not be used with many types of coatings. For example, the chemical nature of silicone hard-coats does not allow them to be easily spray applied without the formation of substantial defects, such as orange peel and surface haze. Other techniques, such as spin coating creates other types of defects, such as flow lines and coating runs, for optically transparent, non-planar parts (e.g., windows).

Therefore, there is a need in the industry to develop a flow, dip, or curtain coating method that will apply a homogeneous coating thickness to the surface of a part so that the part may exhibit similar properties over the entire coated surface area.

### SUMMARY

In overcoming the drawbacks and limitations of applying a coating to a plastic panel using a conventional flow or dip coating process, a flow coating process for a plastic panel with a weather resistant coating system having relatively uniform thickness is presented. This coating process involves placing a plastic panel at a predetermined coating angle (φ) with respect to the ground; applying a first coating layer from a first end to a second end and on at least one side of a plastic panel; allowing the first coating layer to partially flash-off or dry on the plastic panel; rotating the plastic panel by about 180 degrees; applying a second coating layer on top of the first coating layer from the second end to the first end and on at least one side of the plastic panel; allowing the second coating layer to partially flash-off or dry on the first coating layer; and curing the first and second coating layers on the plastic panel.

In one embodiment of the present invention, the first and second coating layers may be different in composition or similar in composition. Examples of coating layers of different composition include, but are not limited to, an acrylic primer and a silicone hard-coat.

In another embodiment of the present invention the flow coating process is an automated process. Dip coating and curtain coating are examples of such an automated process.

In another embodiment of the present invention, the first coating layer is cured prior to rotating the part and the application of the second coating layer. The first and second coating layer may be cured by thermal heat, exposure to radiation, or a mixture thereof.

In yet another embodiment of the present invention the predetermined coating angle (φ) is between about 170 degrees and about 90 degrees. The first and second coating layers may be applied to both sides of the plastic panel.

In yet another embodiment of the present invention the additional step of applying at least one additional protective coating layer onto the surface of the coated part is included in the process. This additional protective coating layer is applied by a vacuum deposition technique, such as expanding thermal plasma PECVD, among others.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic of a flow coating process for a plastic part according to one embodiment of the present invention.

FIG. 2A is a cross-sectional view taken along line A-A from FIG. 1 representing the coating profile obtained by conventional flow coating.

FIG. 2B is a cross-sectional view taken along line B-B from FIG. 1 representing the coating profile obtained according to one embodiment of the present invention.

FIG. 3 is a graphical representation of the modeled lifetime expected for a part coated using a conventional flow coating process plotted as a function of position (top to bottom) of the part.

FIG. 4 is a graphical representation of the modeled lifetime expected for a part coated using a flow coating process according to one embodiment of the present invention plotted as a function of position (top to bottom) of the part.

FIG. 5A is a schematic of a flow coating station showing a coating angle (φ) of about 90 degrees.

FIG. 5B is a schematic of a flow coating station showing a coating angle (φ) of about 150 degrees.

### DETAILED DESCRIPTION

The following description is merely exemplary in nature and is in no way intended to limit the present disclosure or its application or uses. It should be understood that throughout the description and drawings, corresponding reference numerals indicate like or corresponding parts and features.

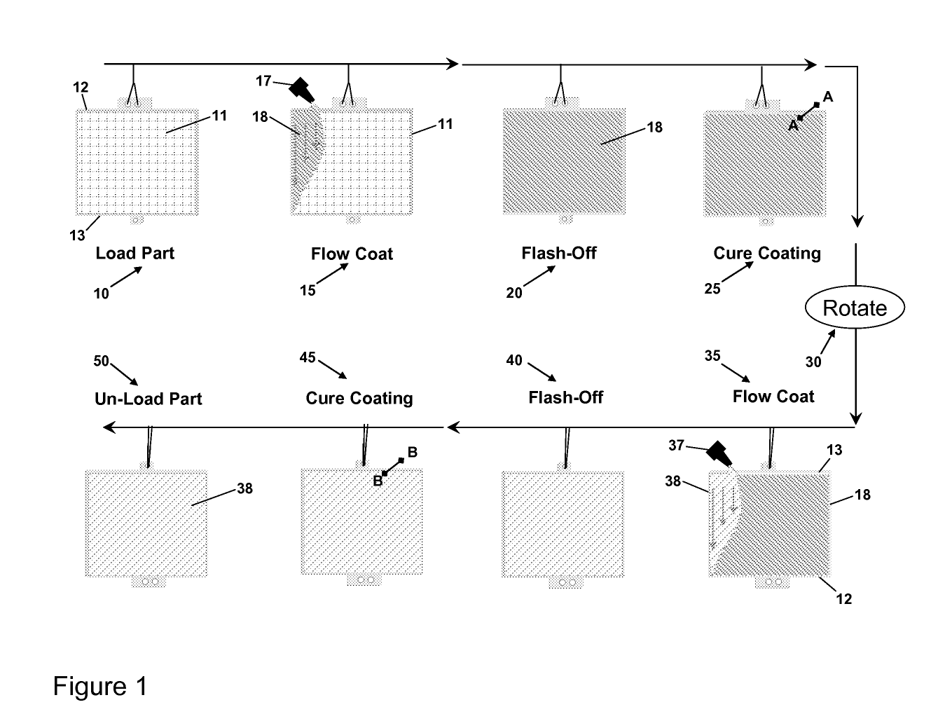

Referring to FIG. 1, a plastic part 11 having a top 12 and bottom 13 is loaded onto a means to convey the part 11 through multiple processing stations according to one embodiment of the present invention. The part 11 may be held via a holding tab or some other graspable feature located near the top 12 of the plastic part 11. The plastic part 11 is moved into a flow coating station 15 where a coating 18 is allowed to flow through a nozzle 17 onto the plastic part 11. The coating 18 flows from the top 12 of part 11 to the bottom 13 of part 11. The coating 18 as applied to part 11 is then allowed to partially “dry” in a flash-off zone 20. During this time, solvent evaporates from the coating 18 and the coating solidifies and adheres to the part 11. Then the coating 18 on the part 11 is subjected to a cure step 25, in which any remaining solvent is evaporated and the coating 18 further cross-links, thereby, enhancing its mechanical and chemical properties, as well as strengthening its adhesion to the part 11. Optionally, the cure step may be bypassed and the coating only allowed to “dry” prior to the rotation of the part and the application of a second coating layer.

After completion of the cure step 25, the coated part is rotated 30 by about 180 degrees and moved to a second flow coating station 35. In this station 35, a coating 38 is allowed to flow through a nozzle 37 onto the surface of the cured coating 18 as applied to the part 11. The coating 38 flows from the bottom 13 of the part 11 to the top 12 of the part 11. This coating 38 is applied onto the surface of the coating 18 already on the part 11 and is then allowed to partially “dry” in a flash-off zone 40. During this time solvent evaporates from the coating 38 and the coating solidifies and adheres to the underlying coating 18. Then the coating 38 is subjected to a cure step 45, in which any remaining solvent is evaporated and the coating 38 further cross-links, thereby, enhancing its mechanical and chemical properties, as well as strengthening its adhesion to the underlying coating 18 on part 11. If the cure of coating 18 was bypassed as described above, the curing of coating 38 also may cure coating 18.

A similar process could be constructed for use with a dip coating or curtain coating method. A curtain coating is essentially an automated version of flow coating where the part is conveyed or passed through a falling curtain (“waterfall”) of coating. The excess coating that runs off of the part is collected in a trough and is pumped back up to the point where it flows once again into the falling curtain. A dip coating involves dipping the part into a tank containing the coating and then pulling the part from the tank. The pulling of the part from the dip tank generates a similar “wedge effect” as observed in the flow and curtain coating processes.

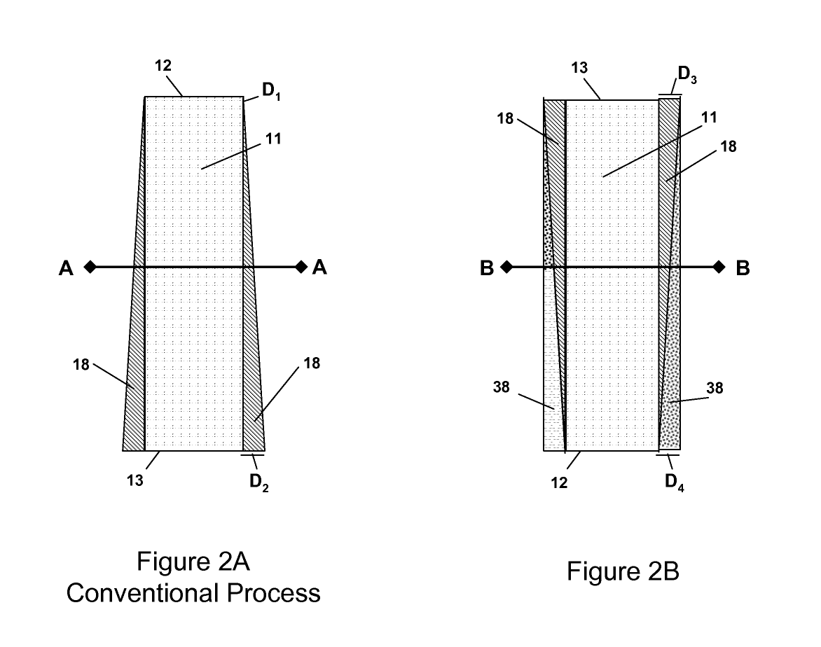

Referring now to FIG. 2A, a cross-section of the plastic part 11 after being flow coated with coating 18 is shown along the line A-A from FIG. 1. This cross-section shows the type of coating thickness profile normally found with the application of a coating to a part using a flow coating technique. One skilled-in-the-art of coating will recognize that a similar thickness profile is observed for coatings applied by dip coating or curtain coating. The thickness of the coating 18 at the top of the part 12 is described by D₁. During the flow coat application, a wedge of coating is created, which results in the thickness of the coating 18 at the bottom 13 of the part 11 being greater than the thickness of the coating 18 at the top of the part 11. The thickness of the coating 18 at the bottom of the part 13 is described by D₂. In other words D₂ is greater than D₁. A gradient in thickness is observed with the thinnest coating near the top of the part and the thickest coating near the bottom of the part. If a second coating layer is flow coated on the part 11 according to a conventional flow coating process, the variation in the overall thickness of the coatings applied near the top and bottom of the part will become much larger. The end result of this phenomenon is the potential for significant variation to occur in the performance of the coating with respect to its location (e.g., relative to being near the top or bottom of the part).

Referring now to FIG. 2B, a cross-section of the plastic part 11 after being flow coated with both coating 18 and coating 38 according to one embodiment of the present invention is shown along the line B-B from FIG. 1. The thickness of the coating 18 and coating 38 at the bottom of the part 13 is described by D₃. During the flow coat application, a wedge of coating 38 is again created. However, since the part 11 has been rotated by about 180 degrees, the thickness of the coating 38 at the bottom 13 of the part 11 is less than the thickness of the coating 38 at the top of the part 11. The overall thickness of the coating 18 and coating 38 at the top of the part 12 is described by D₄. In other words, D₃ may be similar to D₄. This embodiment demonstrates the possibility of creating a coated part having a substantially homogenous coating thickness (D₃˜D₄) from top 12 to bottom 13 of the part 11. However, one skilled-in-the-art will realize that D₃ and D₄ do not have to be approximately equal in order for the coatings to exhibit a significant enhancement in performance. Any decrease in the thickness variation between the coating near the top and bottom resulting from the use of the flow coating method of the present invention would represent an improvement in the performance exhibited by a part coated using a conventional flow coating method. One skilled-in-the-art will further recognize that a similar effect would be observed if the first flow coating was applied from the bottom to the top of the part and the second flow coating applied from the top to the bottom of the part, as well as if more than two coatings or coating layers were applied.

Optionally, the flow, dip, or curtain coating method of the present invention may be coupled with other means to increase the thickness of a coating layer. Such other means include, but are not limited to, (a) increasing the solids content of the coating applied to the part; (b) setting the angle of the part with respect to the ground to less than 90 degrees for the flow application of the coating and/or for the period over which the coating is allowed to dry or flash-off; (c) providing a sacrificial plastic “tab” at the top of the part to be coated; or (d) applying the coating in a multi-layer application process with various flash-off or “dry” times.

The plastic part 11 may be comprised of any thermoplastic or thermoset polymeric resin. The polymeric resins include, but are not limited to, polycarbonate, acrylic, polyarylate polyester, polysulfone, polyurethane, silicone, epoxy, polyamide, polyalkylenes, and acrylonitrile-butadiene-styrene (ABS), as well as copolymers, blends, and mixtures thereof. The plastic part 11 may be formed through the use of any known technique to those skilled in the art, such as molding, thermoforming, or extrusion.

In another embodiment, the part 11 is an injection molded automotive plastic window or panel. Typically, a plastic window is substantially comprised of a transparent region, but may contain opaque regions, such as but not limited to an opaque frame or border. The preferred transparent, thermoplastic resins for use in forming a window include, but are not limited to, polycarbonate, acrylic, polyarylate, polyester, and polysulfone, as well as copolymers and mixtures thereof.

The coatings 18 & 38 applied by the flow, dip, or curtain coating process of the present invention may be comprised of but not limited to silicones, polyurethanes, acrylics, polyesters, polyurethane-acrylates, and epoxies, as well as mixtures or copolymers thereof. The coatings preferably includes ultraviolet (UV) absorbing molecules, such as hydroxyphenyltriazine, hydroxybenzophenones, hydroxylphenylbenzotriazoles, hydroxyphenyltriazines, polyaroylresorcinols, 2-(3-triethoxysilylpropyl)-4,6-dibenzoylresorcinol) (SDBR), 4,6-dibenzoylresorcinol (DBR), and cyanoacrylates among others.

The coatings 18 & 38 may be the same or similar in nature, resulting in a single coating composition or be different in nature, resulting in distinct layers having a different composition. In this latter case, the distinct layers may include a primer coating 18 and a topcoat 38. A primer coating 18 may aid in adhering the topcoat 38 to the plastic part 11. The primer coating for example may include, but not be limited to, acrylics, polyesters, epoxies, and copolymers and mixtures thereof. The topcoat 38 may include, but not be limited to, polymethylmethacrylate, polyvinylidene fluoride, polyvinylfluoride, polypropylene, polyethylene, polyurethane, silicone, polymethacrylate, polyacrylate, polyvinylidene fluoride, silicone hardcoat, and mixtures or copolymers thereof. One specific example of a coating system comprising distinct coating layers includes the combination of an acrylic primer (SHP401 or SHP470, Momentive Performance Materials, Waterford, N.Y.) and a silicone hard-coat (AS4000 or AS4700, Momentive Performance Materials).

A variety of additives may be added to either or both the primer coating 18 and the topcoat 38, such as colorants (tints), Theological control agents, mold release agents, antioxidants, and IR absorbing or reflecting pigments, among others. The type of additive and the amount of each additive is determined by the performance required by the plastic part to meet the specification and requirements for use in any selected application, such as an automotive window.

The thickness of each cured coating 18 & 38 may range from less than one micrometer to greater than about 75 micrometers. The coatings may be cured by exposure to thermal heat, UV radiation, or mixture or combination thereof. The least variation in overall coating thickness will occur when the average thickness of each coating 18 & 38 are about equivalent. In this case, a similar amount of an additive in each coating 18 & 38 will provide a part that exhibits uniform properties that arise from the coating over the entire (top to bottom) coated surface of the part.

In another embodiment of the present invention, when the coating composition of two layers is similar, it is possible that the curing step for the first applied layer can be eliminated. A flash-off or “drying” period may be enough to allow a second layer to be applied without significantly re-dissolving the “dried” first layer. If the first layer is fully cured prior to the application of the second layer it is possible that the two layers may not adequately adhere to each other.

Optionally, the coatings 18 & 38 applied by flow, dip, or curtain coating and subsequently cured may be over-coated via the deposition of an abrasion resistant film. This abrasion resistant film may be either comprised of one layer or a combination of multiple interlayers of variable composition. The abrasion resistant film may be applied by any vacuum deposition technique known to those skilled-in-the-art, including but not limited to plasma-enhanced chemical vapor deposition (PECVD), expanding thermal plasma PECVD, plasma polymerization, photochemical vapor deposition, ion beam deposition, ion plating deposition, cathodic arc deposition, sputtering, evaporation, hollow-cathode activated deposition, magnetron activated deposition, activated reactive evaporation, thermal chemical vapor deposition, and any known sol-gel coating process.

In one embodiment of the present invention a specific type of PECVD process used to deposit the abrasion resistant film comprising an expanding thermal plasma reactor is preferred. This specific process (called hereafter as an expanding thermal plasma PECVD process) is described in detail in U.S. patent application Ser. No. 10/881,949 (filed Jun. 28, 2004) and U.S. patent application Ser. No. 11/075,343 (filed Mar. 8, 2005), the entirety of both being hereby incorporated by reference. In an expanding thermal plasma PECVD process, a plasma is generated via applying a direct-current (DC) voltage to a cathode that arcs to a corresponding anode plate in an inert gas environment. The pressure near the cathode is typically higher than about 150 Torr, e.g., close to atmospheric pressure, while the pressure near the anode resembles the process pressure established in the plasma treatment chamber of about 20 mtorr to about 100 mtorr. The near atmospheric thermal plasma then supersonically expands into the plasma treatment chamber.

The reactive reagent for the expanding thermal plasma PECVD process may comprise, for example, octamethylcyclotetrasiloxane (D4), tetramethyldisiloxane (TMDSO), hexamethyldisiloxane (HMDSO), vinyl-D4 or another volatile organosilicon compound. The organosilicon compounds are oxidized, decomposed, and polymerized in the arc plasma deposition equipment, typically in the presence of oxygen and an inert carrier gas, such as argon, to form an abrasion resistant film.

The abrasion resistant film may be comprised of aluminum oxide, barium fluoride, boron nitride, hafnium oxide, lanthanum fluoride, magnesium fluoride, magnesium oxide, scandium oxide, silicon monoxide, silicon dioxide, silicon nitride, silicon oxy-nitride, silicon oxy-carbide, hydrogenated silicon oxy-carbide, silicon carbide, tantalum oxide, titanium oxide, tin oxide, indium tin oxide, yttrium oxide, zinc oxide, zinc selenide, zinc sulfide, zirconium oxide, zirconium titanate, or a mixture or blend thereof. Preferably, the abrasion resistant film is comprised of a composition ranging from SiOₓ to SiOₓC_{y}H_{z} depending upon the amount of carbon and hydrogen atoms that remain in the deposited film.

The following specific examples are given to illustrate the invention and should not be construed to limit the scope of the invention.

### EXAMPLE 1

### Conventional Flow Coating

A polycarbonate panel is flow coated via a conventional method with an acrylic primer (e.g., SHP-9X, Exatec, LLC, Wixom, Mich.) having nearly no functioning ultraviolet absorbers (UVA) and then after flash and curing, this primer is over-coated with a silicone hard-coat (e.g., SHX, Exatec, LLC) having enough UVA to make it a 10 year weatherable coating. Due to the fundamental nature of flow coating there is a so-called “wedge effect” where the coating on the top of the part is thinner than the coating on the bottom of the part. For a silicone hard-coat flow coated onto a 730 mm long×730 mm wide×4 mm deep polycarbonate panel, the coating thickness is about 2 micrometers measured one 25.4 mm down from the top of the glazing and about 9 micrometers measured at 25.4 mm up from the bottom of the part. The silicone hard-coat has a UV index of 0.2 Absorbance/micrometer, with a stability of 0.05 Absorbance/MJ. The thickness variation measured for the primer applied by flow coating is approximately on the order of about 0.15 micrometers at the top of the part and approximately 0.50 micrometers at the bottom of the part.

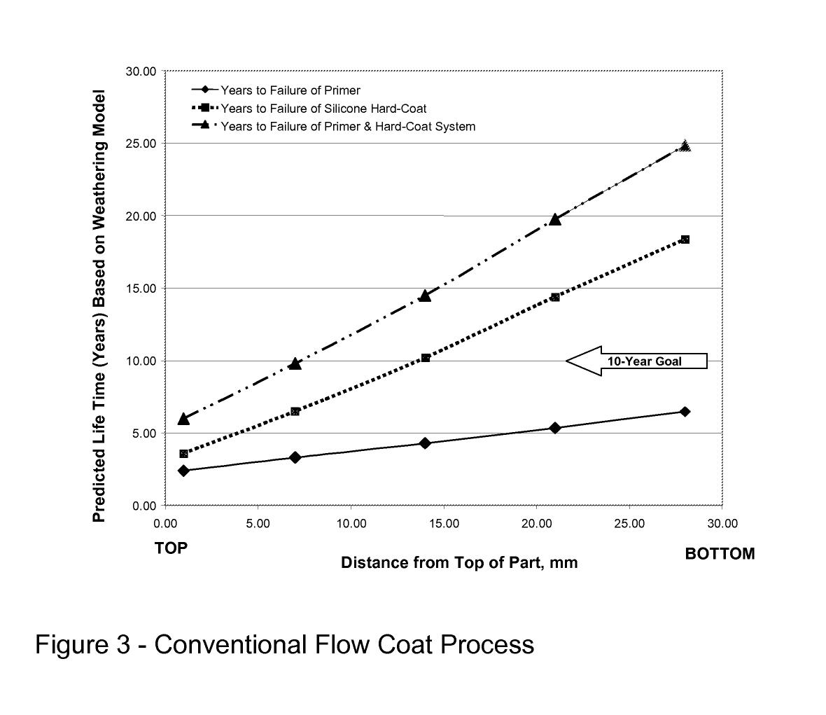

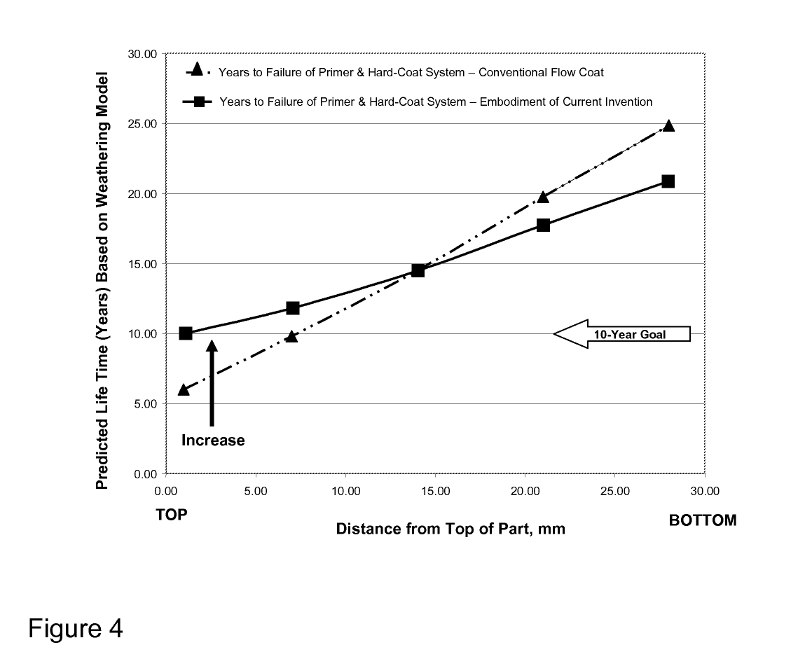

When the measured thickness values along with the known UV index for the coating is placed into a weathering model as is well known to anyone skilled-in-the-art, one can calculate that below a 6.5 micrometer coating, you do not have a part that will exhibit a 10-year lifetime on a global basis. In fact, the top portion of the part will weather much quicker than the bottom portion of the part as shown in FIG. 3. The top of the part is expected to have a lifetime on the order of only about 6 years, while the bottom of the part will survive weathering for about 25 years. A more thorough discussion of weathering models may be found in the literature, including an article by J. E. Pickett, “UV Absorber Permanence and Coating Lifetimes”, Journal of Testing and Evaluation, 32(3), 240-245 (2004), which is hereby incorporated by reference.

Due to the solubility limits of the UVA in the primer coating and the occurrence of the “wedge” effect, merely increasing the concentration of UVA in the primer is not enough to achieve 10 year weatherability (see FIG. 3). The thickness of the primer at the top of the part is far too low to have 10 year performance, even though the UV index for the primer has been reported to be about 2 Absorbance/micrometer (0.8 absorbance/0.4 micron).

### EXAMPLE 2

### Comparison with Invention

To achieve 10 year weatherability, the same coatings as used in Example 1 need to be applied using the flow coating process according to one embodiment of the present invention. If the primer (with UVA) are flow coated on to the part in one direction (e.g., from bottom to top) and then, after flash and oven curing, the silicone hard-coat is flow coated on to the part from top to bottom, the resulting coated part will achieve a 10 year performance lifetime over the entire coated surface (e.g., top to the bottom) of the part as shown in FIG. 2. The top of the part flow coated according to one embodiment of the present invention is expected to exhibit a lifetime of 10 years and the bottom of the part a lifetime of about 21 years. Thus the lifetime expected near the top of the window has increased from 6 years (Conventional flow coating—Example 1) to 10 years, while the lifetime expectancy near the bottom of the window is only slightly reduced from 25 years (Example 1) to 21 years.

This example demonstrates that the weatherability goal for an automotive glazing or plastic window of 10 years is achievable for a window coated according to the flow coating process of the present invention, while a conventional flow coating method using the same coatings will fall short of the goal.

### EXAMPLE 3

### Coating of Same Composition

In this example two layers of a silicone hard-coat were applied to a polycarbonate window primed with an acrylic primer (SHP-9X, Exatec LLC, Wixom, Mich.) with an average thickness of about 0.40 micrometers. A comparison between a conventional flow coating process and the flow coating process according to one embodiment of the present invention was done. The first layer of a silicone hard-coat (SHX, Exatec LLC, Wixom, Mich.) was applied near the top of the part and the coating allowed to flow down the part. The coating was allowed to flash-off or “dry” for 12 minutes. Then a second layer of the same silicone hard-coat was applied (a) according to a conventional flow coat process and (b) according to one embodiment of the present invention. In the conventional flow coat process the second layer of the silicone hard-coat was applied near the top of the part in a similar fashion as was done with the first coating layer. For the flow coating process of the current invention, the window was rotated 180 degrees and the second coating layer was applied near the bottom of the window and the coating was allowed to flow towards the top of the window. After the second coating layer was allowed to flash-off or “dry”, the coated window was thermally heated and the coatings fully cured. The overall thickness of the silicone hard-coat was then measured with the results being shown in Table 1.

This example demonstrates that the coating thickness near the top of the window can be increased using the flow coating process of the present invention. In this case, the thickness at the top of the window was observed to increase from 3.0 micrometers to about 6.5 micrometers. In comparison, adding a second layer of the silicone hard-coat according to conventional flow coating was only capable of modestly increasing the thickness of the silicone hard-coat near the top of the window from 3.0 micrometers to 4.1 micrometers.

TABLE 1

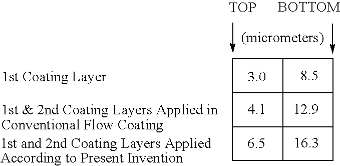

### EXAMPLE 4

### Coating Angle Adjustments

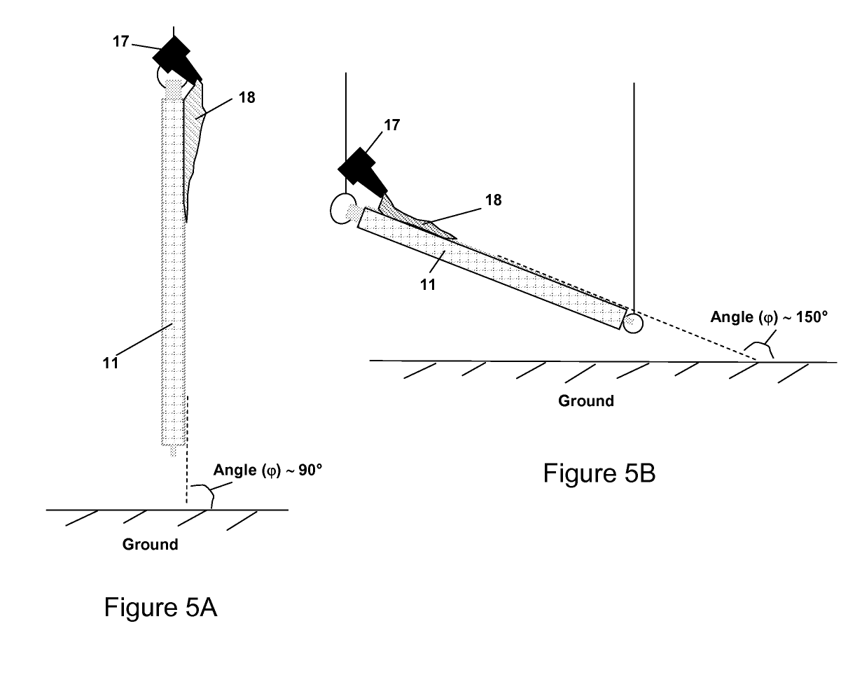

In this example, two layers of a silicone hard-coat having a solids content of 29% was applied to a polycarbonate window having a thin acrylic primer layer (average thickness about 0.4 micrometers). The first silicone hard-coat layer was applied to one window held in a conventional fashion with the surface (top to bottom) upon which the coating is applied makes an angle (φ) with the ground of about a 90 as shown in FIG. 5A. The first silicone hard-coat layer was also applied to one window held so that the window's surface (top to bottom) upon which the coating will flow made an angle (φ) with the ground of about 150 degrees as shown in FIG. 5B. In each case, the 1^{st} coating layer was applied near the top of the window and the coating flowed towards the bottom of the window. The first coating on each window was then allowed to flash-off or “dry” for a period of about 8 minutes. Then the windows were rotated by 180 degrees with the coating angle (φ) of 90 degrees or 150 degrees being maintained for each corresponding window. A second layer of the silicone hard-coat was applied to each window and after being allowed to flash-off, each window was fully cured. The thickness of the overall silicone hard-coat coating on each window was finally measured with the results being shown in Table 2.

TABLE 2

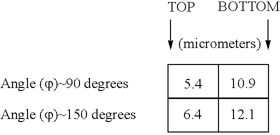

This example demonstrates that a change in the angle at which the coating is allowed to flow can be used in addition to the rotation of the window between coating layers to increase the thickness of the overall coating applied to the part. One skilled-in-the-art would realize that many different coating angles (φ) could be utilized depending upon the desired thicknesses for the coating layers.

A person skilled in the art will recognize from the previous description that modifications and changes can be made to the present invention without departing from the scope of the invention as defined in the following claims. A person skilled in the art will further recognize that the weathering and coating thickness measurements described are standard measurements that can be obtained by a variety of different test methods. The test methods described in the examples represents only one available method to obtain each of the required measurements.

What is claimed is:

1. A process for flow coating a plastic panel with a weather resistant coating system of relatively uniform thickness, the process comprising:
placing a plastic panel at a predetermined coating angle (φ) with respect to the ground;
applying a first coating layer from a first end to a second end and on at least one side of a plastic panel;
allowing the first coating layer to partially flash-off or dry on the plastic panel;
rotating the plastic panel by about 180 degrees;
applying a second coating layer on top of the first coating layer from the second end to the first end and on at least one side of the plastic panel;
allowing the second coating layer to partially flash-off or dry on the first coating layer; and
curing the first and second coating layers on the plastic panel.

2. The process of claim 1, further comprising the step of curing the first coating layer prior to rotating the plastic panel and applying the second coating layer.

3. The process of claim 2, wherein the first coating layer is cured by thermal heat, exposure to radiation, or a mixture thereof.

4. The process of claim 2, wherein the first and second coating layers are different in composition.

5. The process of claim 4, wherein the first coating layer is an acrylic primer and the second coating layer is a silicone hard-coat.

6. The process of claim 1, wherein the plastic panel includes a primer layer to promote adhesion with the first coating layer.

7. The process of claim 6, wherein the primer layer is an acrylic primer.

8. The process of claim 7, wherein the first and second coating layers are similar in composition.

9. The process of claim 8, wherein the first and second coating layers are a silicone hard-coat.

10. The process of claim 1, wherein the first and second coating layers are selected as one from the group of silicones, polyurethanes, acrylics, polyesters, polyurethane-acrylates, epoxies, and mixtures or copolymers thereof.

11. The process of claim 1, wherein the first end of the plastic panel is the top of the panel.

12. The process of claim 1, wherein the second end of the plastic panel is the bottom of the panel.

13. The process of claim 1, wherein the process for flow coating a plastic panel is an automated process.

14. The process of claim 13, wherein the automated process is dip coating or curtain coating.

15. The process of claim 1, wherein the first coating layer is allowed to flash-off or dry for a period greater than about 5 minutes.

16. The process of claim 1, wherein the second coating layer is cured by thermal heating, exposure to radiation, or a mixture thereof.

17. The process of claim 1, wherein both sides of the plastic panel are coated with the first coating layer.

18. The process of claim 1, wherein both sides of the plastic panel are coated with the second coating layer.

19. The process of claim 1, wherein the predetermined coating angle (φ) is between about 170 degrees and about 90 degrees.

20. The process of claim 19, wherein the predetermined coating angle (φ) is between about 90 degrees.

21. The process of claim 1, further comprising applying at least one additional protective coating layer onto the surface of the coated part.

22. The process of claim 21, wherein the at least one additional protective coating layer is applied by a vacuum deposition technique selected as one of plasma-enhanced chemical vapor deposition (PECVD), expanding thermal plasma PECVD, plasma polymerization, photochemical vapor deposition, ion beam deposition, ion plating deposition, cathodic arc deposition, sputtering, evaporation, hollow-cathode activated deposition, magnetron activated deposition, activated reactive evaporation, thermal chemical vapor deposition, or any known sol-gel coating processes.

23. The process of claim 22, wherein the vacuum deposition technique is expanding thermal plasma PECVD.
